(19) United States
(12) Patent Application Publication
(10) Pub. No.: US 2013/0345593 A1
(43) Pub. Date: Dec. 26, 2013

(54) System and Method for Assessing an Individual's Impairment

(71) Applicants: Adam Burns, Rochester, NY (US); Max Neumeyer, Wellesley, MA (US)

(72) Inventors: Adam Burns, Rochester, NY (US); Max Neumeyer, Wellesley, MA (US)

(21) Appl. No.: 13/923,853

(22) Filed: Jun. 21, 2013

Related U.S. Application Data
(60) Provisional application No. 61/662,440, filed on Jun. 21, 2012.

(51) Int. Cl. G06F 19/00

(52) U.S. Cl. CPC G06F 19/345
USPC 600/558; 600/300

(57) ABSTRACT

A method implemented in a computing system is provided to determine an individual's level of impairment through a comparison of an individual's pre-impairment base-line score, and an individual's post-impairment score through the system's administration of a plurality of tasks to completed by the individual, and to be calculated and stored by the system.

### CROSS REFERENCE TO RELATED APPLICATION

This application claims the benefit of and takes priority from U.S. Provisional Patent application Ser. No. 61/662,440 filed on Jun. 21, 2012, the contents of which are herein incorporated by reference.

### BACKGROUND OF THE INVENTION

1. Field of the Invention

The instant invention relates to a system and method for assessing an individual's impairment through the performance and completion of a plurality of pre-determined tests, and more particularly to a computer-implemented methodology to determine impairment through a comparison of an individual's baseline test results pre-impairment and an individual's test results post-impairment.

2. Description of the Related Art

It is commonly known that intoxicated individuals tend to act as their sober self would never allow and that this compromised rationality or impulsiveness could potentially cause them to make costly social mistakes.

Anyone who has ever been intoxicated could probably tell you that they would never be able to accurately evaluate their precise blood alcohol content or the extent of their impairment without assistance. So how is it possible to know if it's safe to get behind the wheel of a car or which drink is one too many? The root of this problem stems from the fact that alcohol's numerous effects on the body depend on far too many variables, and the way that a couple of drinks affects an individual one day may be completely different than the next. In addition to the difficulties faced in assessing one's own level of intoxication based on self-perceptions skewed by the alcohol consumed, conventional methods of accurate judgment are wrought with problems of their own. Breathalyzers, for instance, are too cumbersome or unwieldy to carry around regularly. While, on the other hand, BAC calculators that make these judgments based on complex calculations are more convenient but tend to be highly inaccurate due to human error. This unbiased or uninhibited, external, judgment of an individual's level of impairment is important in the process of making a wise decision when one's own faculties cannot be trusted.

The Uniform Crime Reports by the FBI cite that there were a total of 1,412,223 arrests made in 2010 for driving under the influence of alcohol (DUI) and another 560,718 arrests were made for drunkenness. These staggering statistics are nothing compared to those who considered it a good idea to drive and were not stopped in time. In 2009 the National Highway Traffic Safety Administration reported a total of 33,808 alcohol induced traffic fatalities.

A large number of studies involving mobile device applications attempting to accurately evaluate some condition of the human user have been proposed to answer questions similar to the one being posed here. Emiliano et al. [2] proposed an application which used an ordinary smart phone to autonomously determine where a person is and what actions they are performing. These readings ranged from working out at the gym to listening to music in the car. In addition to putting together this status of a user, the application (CenceMe) would also share this information via social networking applications such as Facebook or MySpace.

Other mobile systems have also been proposed to answer the question of accurately analyzing a user's various physical conditions as they apply to fields such as personalized healthcare. Preuveneers and Berbers [1] focused on diabetes and more specifically on making diabetics' lives simpler. This mobile healthcare system was designed to assist individuals diagnosed with diabetes by making well-informed decisions on daily drug dosage to achieve and maintain stable blood glucose levels. These complex dosage recommendations are compiled by monitoring user location and activity on a mobile phone, recognizing past behavior and augmenting the recording of blood glucose levels with contextual data.

Mulvenna et al. [4] devised a cognitive prosthetic for people with mild dementia that contains a combination of needs driven tools aimed at assisting users with mild dementia in their daily life. This application for mild dementia patients attempted to answer the posed question of what tools would help an individual suffering from this disease live a more comfortable life. The study began by first answering the question of feasibility just as Emiliano did. This feasibility assessment was done through a set of three iterative studies of a year each. Each study was performed with 15 individuals with mild dementia who were observed and their expressed needs were taken note of. These needs were recorded so that they could be mapped to functional requirements and design specifications. After each yearlong iteration, the prototype application was developed and modified to fit the expressed and observed needs of the patients. Eventually concluding field tests were performed where the latest version of the prototype application was installed on the participant's phones and evaluation of success was measured through interviews, observations, and diaries of individuals. This pair of personalized healthcare applications both used a three-step testing and implementation process similar to the “CenceMe” study.

### SUMMARY OF THE INVENTION

The instant system and method, as illustrated herein, is clearly not anticipated, rendered obvious, or even present in any of the prior art mechanisms, either alone or in any combination thereof. Thus the several embodiments of the instant system and method are illustrated herein.

In one aspect of the instant invention, a computer-implemented system and method is disclosed that based on the assessment of certain skills and abilities that may be affected after an individual's impairment, may be used to judge an individual's level of impairment with the accuracy of commercially available invasive products. Initially, an individual will be required to “personalize” the system prior to implementation and usage by primarily entering personal information that pertains to an impairment calculation, and secondly by providing a reading of their baseline pre-impairment abilities related to the subtests incorporated in the system.

In one embodiment, an individual user of the system may be prompted to enter their gender, height, weight and age. Additionally the user of the system may set their “baseline state” for comparison during impairment by taking tests similar to those that will be administered to measure impairment. Once the system has been calibrated for the individual, the information pertaining to how they act while not impaired will be saved and the application may then be used to gage their impairment level at a later time. Once the user has some level of impairment, the user may utilize the system to complete a set of simple tasks which will evaluate the user on their level of memory impairment, degradation of cognitive or problem solving abilities, level of acute ataxia, vision disruption (specifically diplopia), and delay in reaction time. Their scores on these subtests will then be compared by the system to the baseline that was created and stored in the system by the user pre-impairment.

In another aspect of the instant invention, a system and method for determining impairment of an individual, wherein the system initially comprises a computer-implemented system which will allow users to quantifiably assess their impairment and give them a sense of self-awareness.

There has thus been outlined, rather broadly, the more important features of a system and method for assessing an individual's impairment in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways, including applications involving not only firefighters. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

FIG. 1 illustrates a flow diagram of one embodiment on the instant invention, wherein the system determines and records a baseline pre-impairment score for comparison with a post-impairment score of a user of the system.

FIG. 2 illustrates a flow diagram of one embodiment of the instant invention, wherein the system provides a user with a plurality of input variables to determine a baseline pre-impairment score.

FIG. 3 illustrates a flow diagram of one embodiment of the instant invention, wherein the system requires a user to perform and complete a plurality of tasks to determine a post-impairment score.

FIG. 4 illustrates a diagrammatic perspective view of one embodiment of one task to assess memory impairment of a user of the system during impairment.

FIG. 5 illustrates a diagrammatic perspective view of one embodiment of one task to assess the problem solving ability of a user of the system during impairment.

FIG. 6 illustrates a diagrammatic perspective view of one embodiment of one task to assess the degradation of muscle control of a user of the system during impairment.

FIG. 7 illustrates a diagrammatic perspective view of one embodiment of one task to assess the level of diplopia of a user of the system during impairment.

FIG. 8 illustrates a diagrammatic perspective view of one embodiment of one task to assess the degradation of reaction time of a user of the system during impairment.

FIG. 9 illustrates a diagrammatic perspective view of one embodiment of one task to assess hand-eye coordination of a user of the system during impairment.

FIG. 10 illustrates a diagrammatic perspective view of one embodiment of another task to assess hand-eye coordination of a user of the system during impairment.

FIG. 11 illustrates a block diagram of an exemplary computing system for implementing the method of FIG. 1.

### DETAILED DESCRIPTION OF THE PREFERRED EMBODIMENTS

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

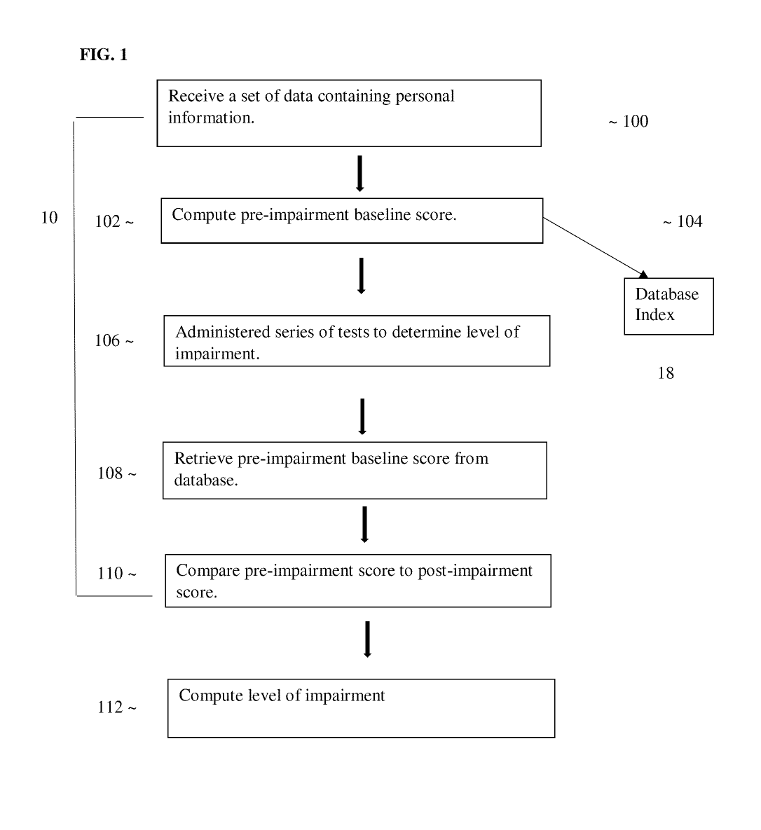

FIG. 1 illustrates a block diagram conceptually illustrating the overall steps of a method 10 of the instant invention implemented within a computing system 40, to assess and determine an individual's level of impairment through a comparison of an individual's pre-impairment baseline score, and an individual's post-impairment results from a series of tests to measure various levels of impairment. Initially, at step 100, a set of data is received by the computing system 40 preferably relating to a user's personal information, including, but not limited to gender, height, weight and age. At step 102 a pre-impairment baseline score of a user is computed based on the set of data received; once the pre-impairment baseline score is computed, the baseline score is stored in a database index 18 at step 104. At step 106, following a period of impairment, a series of tasks are administered to the user by the computing system for completion, to determine the user's level of impairment. Once the series of tasks have been completed, at step 108 the pre-impairment baseline score is retrieved from the database index 18. At step 110, the retrieved pre-impairment baseline score is compared the recently calculated post-impairment results of the user. Finally, at step 112, a computation is made to determine whether a user is impaired based on the pre-impairment baseline score and the post-impairment test results.

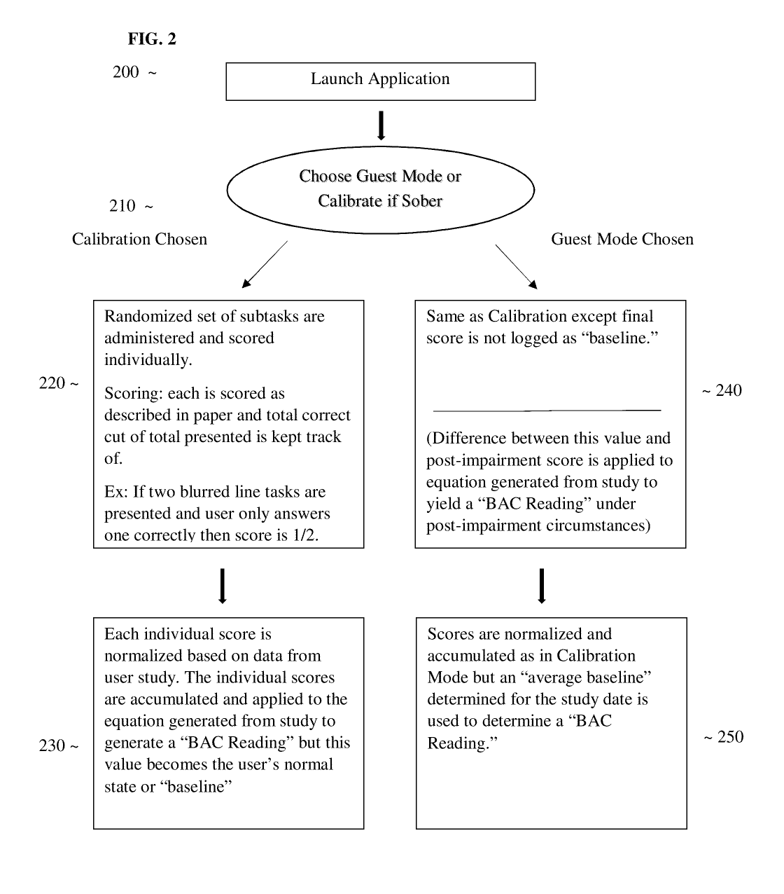

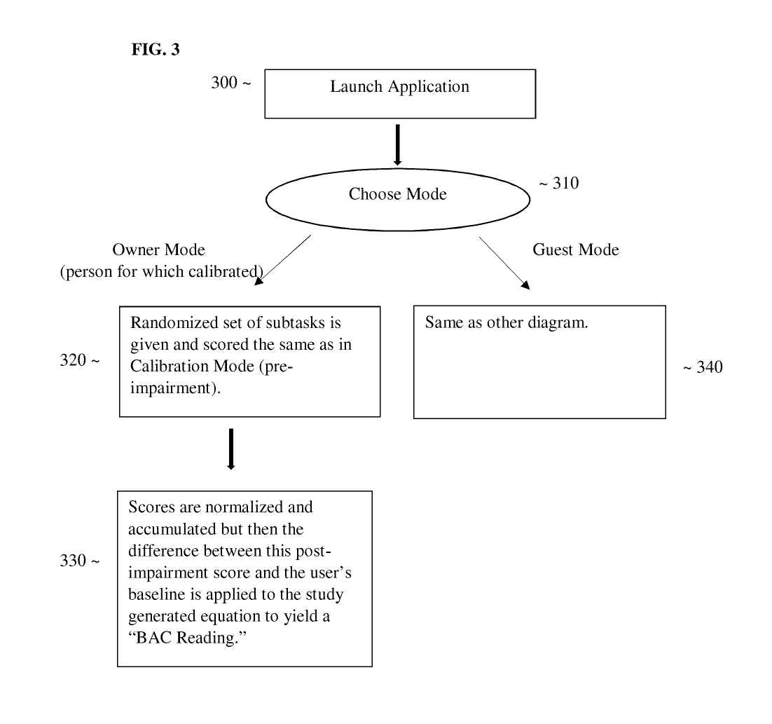

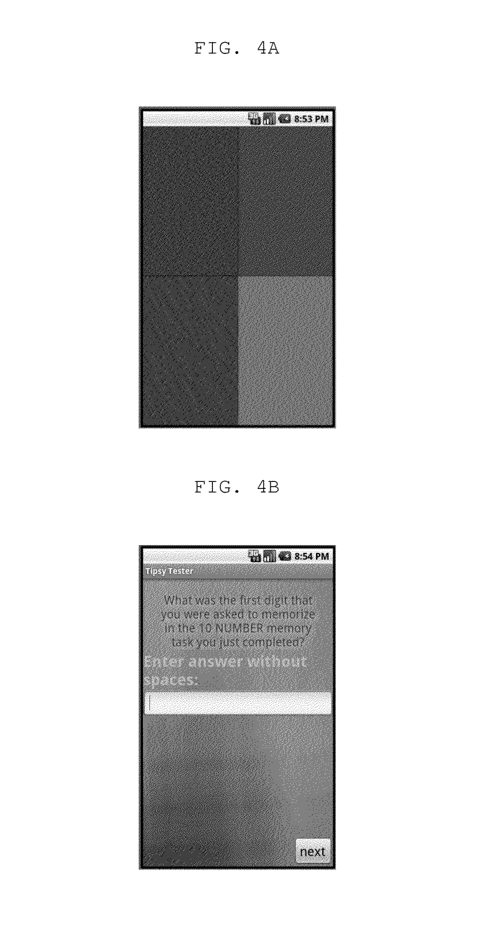

FIG. 2 illustrates a block diagram of one embodiment of a non-calibrated method of the instant invention, wherein the method 20 provides a user with a plurality of input variables to determine a baseline pre-impairment score. At step 200, a mobile application 54 is initiated by a user in order to calculate a base-line score for future comparison. At step 210, a user may seek to calibrate a base-line score in order to store the base-line of the user in the database index 18, or the user may not have the computing system 40 store the base-line score. If the user requests the computing system 40 to store the base-line score in the database index 18, then at step 220, the a plurality of tasks are administered for the user to complete, wherein each task (see FIGS. 4-8) generates a computed score. Following completion and subsequent computing and scoring of each task, each score is stored in the database base index 18 to eventually compute a base-line score of the user. Next, at step 230, each individual score is normalized and recorded, that was stored in the database index 18 at step 220, against a pre-determined data set to provide a user's normal state or base-line. Conversely, if the user does not want to record the base-line score in the database index 18, then at step 240, a plurality of tasks are administered by the computing system (see FIG. 3) to determine whether the user is in a state of impairment, and finally at step 250, the computing system 40 calculates the user's score for comparison against a pre-determined “average” base-line stored in the database index 18.

FIG. 3 illustrates a block diagram of one embodiment of the calibrated method of the instant invention, wherein the method 30 provides a user with a plurality of input variables to determine a post-impairment score for comparison with a base-line score of a user calculated and described in FIG. 2. At step 300, a mobile application 54 is initiated by a user in order to calculate a post-impairment score. At step 310, a user may seek to calibrate a post-impairment score in order to retrieve a user's previously calculated base-line score from the database index 18 for future comparison, or the computing system may compare the post-impairment score against an average stored in the database index 18, if the user did not complete any pre-impairment tasks. If the baseline score is retrieved from the database index 18, then at step 320, the a plurality of tasks are administered by the computing system for the user to complete, wherein each task (see FIGS. 4-8) is computed and scored individually. Following the completion and scoring of each task by the system 10, the system 10 stores each score in the database index 18 to eventually compare against a base-line score of the user. Next, at step 330, each individual score recorded at step 320 is normalized against a pre-determined data set stored in the database index 18 to provide a user's impairment score for comparison with the base-line score. If the user does not want to record the base-line score in the database index 18, then at step 340, a plurality of tasks are administered by the computing system to determine whether the user is in a state of impairment, and finally at step 350, the user's score is computed for comparison against a pre-determined “average” base-line stored in the database index 18.

FIGS. 4A-4C illustrates a diagrammatic perspective view of one embodiment of a memory impairment task administered by the computing system 40 to determine a user's overall level of impairment in comparison to a pre-recorded baseline score stored in the database index 18 within the computing system 40. According to one embodiment of the instant invention, the system may determine and test the memory impairment of an individual by at least three types of tasks that preferably fall into two categories. In one embodiment, the system determines the memory impairment by the “Simon Says” task and a pair of questioning methods (implicit and explicit).

### “Simon Says”

As shown in FIG. 4A, the “Simon Says” task consists of a plurality of multi-color quadrants, wherein the system presents a color pattern that the user must reconstruct to the best of their abilities. The system computes a score for this sub-task by simply counting the number of correct rounds that the user completes (corresponding to length of longest pattern) before failing. This pattern length score is then normalized, for use in the scoring of the total set of tasks.

### Interspersed Questions (Implicit)

The implicit questioning portion of the application as shown in FIG. 4B below, the computing system 40 generates a question and the users answer is entered into the computing system 40. In one embodiment of the instant invention, the computing system 40 testing sequence comprises at least two implicit questions interspersed between the other tasks. The score for this sub-task is simply either one point added to the users previously accumulated implicit questioning score or zero points added to the composite implicit questioning score. In other words if the user answers correctly then they gain one point on their pre-normalized implicit questioning score but if they answer incorrectly no points are added.

After both implicit questions are answered the subject's score (either 0, 1, or 2 points) is normalized for use in the scoring of the total set of tasks.

### Interspersed Questions (Explicit)

As shown in FIG. 4C, the explicit questioning portion of the testing process of the system 40, is preferably in two separate forms. This task either consists of a set of 10 letters or 10 numbers that were displayed to the user for approximately fifteen seconds. After the pre-set time limit the character string disappears and is replaced by an answer box in which the user must recreate the string. Each test sequence currently contains one type of each explicit questioning type (1 letter and 1 number) interspersed between the other tasks of the progression.

In contrast to the implicit questioning method of scoring the explicit questions are not a cumulative score for the two different instances presented to the subject. Each type (letter/number memorization) is scored separately out of ten and normalized separately for later use in the scoring of the total series of tasks.

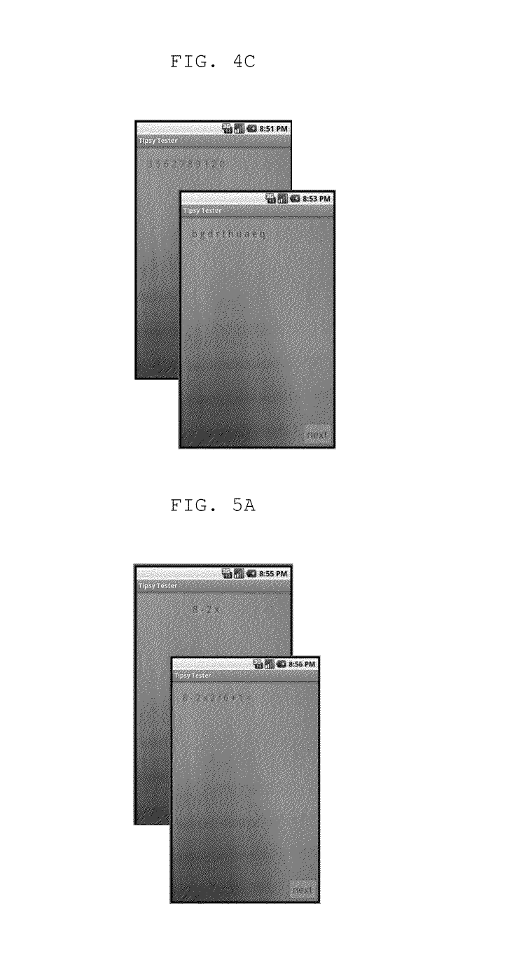

FIGS. 5A-5B illustrate a diagrammatic perspective view of one embodiment of a task provided by the system 40 to assess a user's problem solving ability in determining an overall level of impairment in comparison to a pre-recorded baseline score with the system 40.

### Math Progression

In this task, the system 40 provides for all calculations to result in integers, each operator (+, −, x, /) was used once, and only single digit numbers were presented in the equation, wherein a single digit or operator reveal process was executed by sliding the entire equation string in from right to left and fading it out after the entire equation has been shown as shown in FIG. 5A. After the completed equation disappears an answer box appears to receive the user's answer. In one embodiment, the system provides at least five progressions per testing set. Each of the progressions is scored to be either correct or in correct, earning 1 point or 0 points respectively and their cumulative score on the 5 sequences (0-5 points) is normalized for use in the scoring of the total set of tasks.

### Mental Rotation

As shown in FIG. 5B, the system 40 provides a second task to test an individual's problem solving ability, wherein the system provides a set of at least four images, and asked to pick the one on the right that represents a rotated version of the image on the left. When the user completes one mental rotation task per testing sequence, the system gives 1 point for a correct response and 0 points for an incorrect answer. The users score on the mental rotation sub-task is also normalized for the final scoring of the testing sequence.

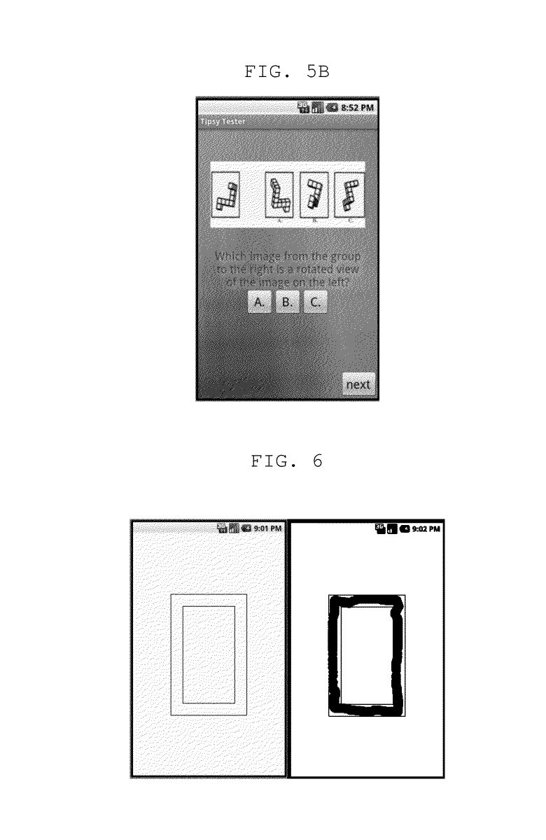

FIG. 6 illustrates a diagrammatic perspective view of one embodiment of a task provided by the system 40 to assess a user's degradation of muscle control in determining an overall level of impairment in comparison to a pre-recorded baseline score with the system 40.

### Shape Draw

As shown in FIG. 6, the system 40 generates a shape and instructs the user to trace within the lines of the shape with their finger to the best of their ability. The test begins when the user first interacts with the system by placing a finger on the shape generated by the system 40, and ends when they lift their finger off the shape. The system 40 also allows the user to easily see when they have gone outside of the shapes bounding lines as the traced path changes color from dark blue to bright orange.

Scoring of this sub-task was slightly more complex than the other tasks as there was no straightforward right or wrong answer. Unlike the other tasks a user's score here has negative connotation because it is the number of instances and duration of the instances in which the user's finger exits the shape outline. To quantify this relationship and calculate a score the number of individual circles (the traced line is made up of a multitude of closely spaced circles) that fall outside the shape (orange) is noted. This score fits with the other scores of the total sequence after it is normalized based on the total set of user data giving it a positive correlation like the others.

FIG. 7 illustrates a diagrammatic perspective view of one embodiment of a task provided by the system 40 to assess a user's level of diplopia in determining an overall level of impairment in comparison to a pre-recorded baseline score with the system 40.

### Line Counting

As shown in FIG. 7, the system 40 generates a grouping of lines and then the system 40 provides a scrollable menu of possible counts for the user to select the correct amount of lines presented by the system 40. In one embodiment, the system 40 generates at least two line counting tasks and they are randomly placed amongst the other tasks. For this task the system 40 awards the user 1-point for a correct answer or 0 points for an incorrect answer and it is the accumulation of the score on both versions that is normalized for later total scoring.

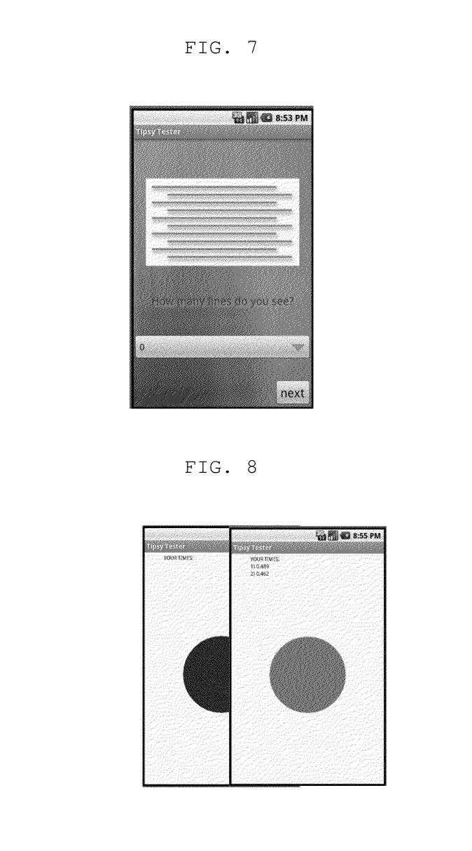

FIG. 8 illustrates a diagrammatic perspective view of one embodiment of a task provided by the system 40 to assess a user's degradation of reaction time in in determining an overall level of impairment in comparison to a pre-recorded baseline score with the system 40.

### Random Dot

As shown in FIG. 8, the system 40 generates a 4-trial random dot reaction timer (random dot) and the task is started when the large, dark circle in the center of the screen lights up four distinct times. The user reacts to the changing of the circles color (lighting up) by tapping the system 40 to stop the timer. The time between the circle lighting up and the user stopping the timer is registered as their reaction time. A total of 4 reaction times are gauged and an average is calculated.

Scoring of the reaction timer sub-task is done in the application, as it is done in the prototype version, by taking the average of the 4 reaction time readings provided by the user's tapping on the screen. This average reaction time is normalized, just as all the sub-task scores are, for use in the total sequence scoring.

In addition to the tasks described above, additional embodiments may be contemplated for the computer-implemented system and method which may be applied to such impairments, including but not limited to intoxication, evaluation of Dementia, Alzheimer's, and other brain disorders.

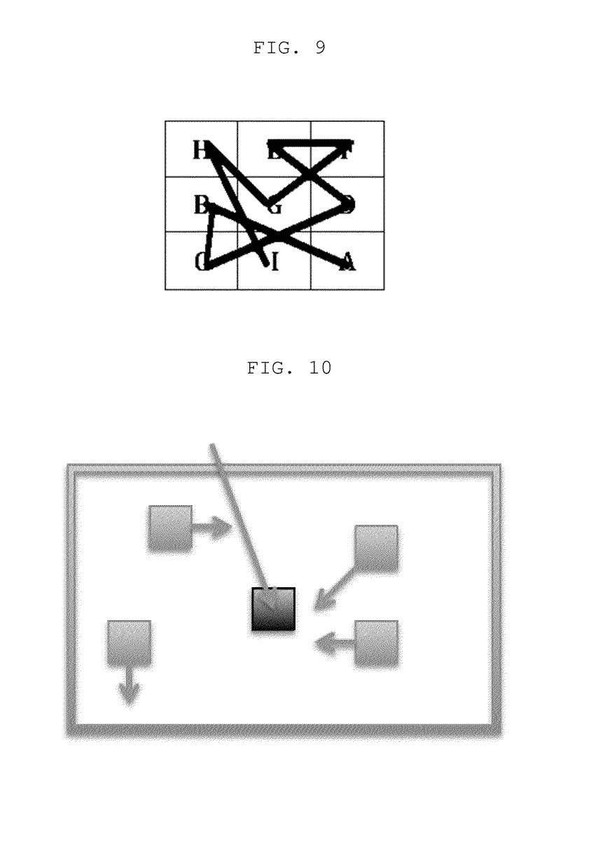

Furthermore, the instant invention may incorporate a variety of tasks described below to either modify, add or substitute to an individual's testing pattern, including, but not limited to: a heart rate monitor, an eye movement/tracker, slurred speech recognition, an individual's body temperature, a writing composition task, wherein a user of the system 40 is prompted to enter a couple lines on a given subject and then the system 40 analyzes the text for both grammatical and spelling errors, a user may drag and drop ball into a hole that changes location in a pre-determined amount of time, a plurality of tests for hand-eye coordination, alphabet jumble, wherein each of three screens shows a section of the alphabet and the user must draw a line with their finger through each of the letters in order (see FIG. 9), a game where the user is responsible for making sure that your shape does not come in contact with the walls or with some number of other shapes that are moving about the screen in a random fashion (see FIG. 10), a ball in cup game, wherein a cup with a ball attached to in by an elastic strand will be displayed on by the system and the user must toss the ball up and catch it in the cup, a user will be required to draw a straight line with a finger and the system will measure how straight the line is, and finally a balance test, wherein the system 10 is operating on a mobile device, a user will hold the device flat in their hand with one or both feet planted on the ground.

In addition to the above-described tasks that may be employed by the system 40 during a testing sequence of an individual, the system 40 may incorporate other features, including, but not limited to the ability to set a reminder to test yourself at a later time or for a certain day/time, the ability to call nearby Taxi Company if the test is substantially failed, and the ability to post a user's level of impairment to a social media platform along with a user's location data, and the estimated time until a user's level of impairment decrease's to the user's baseline level pre-impairment.

### Impulsiveness Test

This test establishes a long and tedious pattern that the subject must follow and then suddenly breaks the pattern. A more impulsive person will miss this change and attempt to continue the previous pattern and will thus have more misses counted against them.

### Maze Test

Another embodiment of a task that may be employed by the system relates to a maze test that examines fine muscle control and problem solving abilities by asking users to complete a maze without touching the walls of said maze in as little time as was required. The number of times the user collided with the walls of the maze would have then been linked to a reading of fine muscle control abilities. The time component would have provided some indication of problem solving ability degradation's relationship with alcohol consumption by comparison of completion rates for similarly difficult, randomizing, maze tests administered at different levels of drunkenness.

### Balance

This embodiment, relates to a task for holding a device in one hand while balancing on one foot.

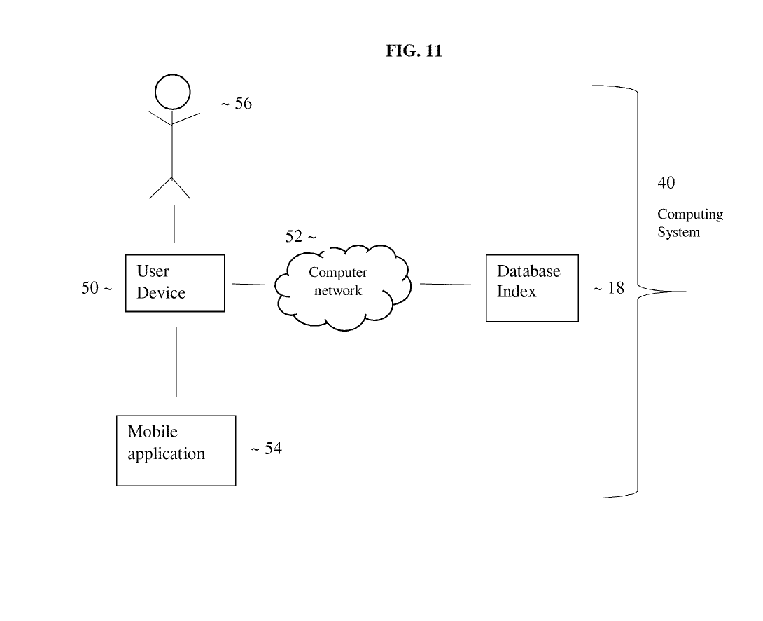

FIG. 11 illustrates a schematic example of a preferred embodiment of a distributed computing system 40 on which the associated methods operate, although the invention is not limited to any particular hardware system. In one embodiment, a user 56 of the computing system 40 initially interacts with the system 40 by downloading a mobile application 54 onto a user's device 50, wherein the mobile application 54 may be available on a shared network environment 52. In one embodiment, the user device 16, includes but is not limited to a smart phone, a tablet, a laptop computer, a desktop computer or any other internet-ready mobile device. Once the user 56 has downloaded the mobile application 54 onto the user's device 50, the mobile application 54 is launched on the user's device 50, for the purposes of determining the user's 12 impairment following the completion of tasks provided by the system 40 both pre and post-impairment.

In conclusion, herein is presented a computer-implemented system and method for assessing an individual's level of impairment. The invention is illustrated by example in the flow diagrams and figures, and throughout the written description. It should be understood that numerous variations are possible, while adhering to the inventive concept. Such variations are contemplated as being a part of the present invention.

What is claimed is:

1. A method implemented in a computing system for assessing an individual's level of impairment comprising the steps of:
receiving a set of data by the computing system;
computing a pre-impairment base-line score based on the set of data received;
storing the pre-impairment base-line score in a database index;
administering a series of tasks to the to ascertain a level of impairment by the computing system;
retrieving the pre-impairment base-line score from the database index;
comparing the store pre-impairment base-line score with the post-impairment results; and
computing whether an individual is impaired.

2. The method of claim 2, wherein the step of determining a pre-impairment base-line score further comprises the steps of:
requesting the computing system to calculate and store the individual's pre-impairment base-line score in the database index;
administering a series of tasks by the computing system for the individual to perform and complete;
computing and scoring each completed task by the computing system individually;
storing each completed task in the database index; and
normalizing each individual stored score by the system against a pre-determined data set stored in the database index.

3. The method of claim 2, wherein the step of determining an individual's post-impairment score further comprises the steps of:
retrieving the individual's pre-impairment base-line score stored in the database index;
administering a plurality of series by the computing system for the individual to perform and complete;
computing and scoring each completed task by computing the system individually;
storing each completed task in the database index; and
normalizing each individual score in the database index by the computing system against a pre-determined data set stored in the database index.

4. The method of claim 2, wherein the plurality of tasks administered by the computing system is selected from the group consisting of: memory impairment, problem solving ability, degradation of muscle control, level of diplopia, and degradation of reaction time.

5. The method of claim 3, wherein the plurality of tasks administered by the system is selected from the group consisting of: memory impairment, problem solving ability, degradation of muscle control, level of diplopia, and degradation of reaction time.

6. The method of claim 4, wherein the method of determining memory impairment comprises the steps of:
generating a plurality of multi-color quadrants;
presenting a color pattern;
instructing the individual to reconstruct the color pattern presented by the system;
computing a score by the system by counting the number of correct rounds that the individual completes; and
storing the score in the database index.

7. The method of claim 4, wherein the method of determining the memory impairment of an individual by the system comprises the steps of:
generating at least one question by the system;
instructing the individual to provide an answer to the system;
determining by the system whether the individual answered the question correctly;
providing one point by the system to the user's overall score if the question is answered correctly; and
awarding zero points by the system to the user's overall score if the question is answered incorrectly.

8. The method of claim 4, wherein the method of determining the memory impairment of an individual by the system comprises the steps of:
generating a string of characters by the system;
displaying the string of characters to the individual for a predetermined amount of time;
removing the string of characters by the system;
instructing the individual by the system to recreate the string of characters previously displayed; and
calculating a score by the system based on the correct amount of characters entered by the individual into the system.

9. The method of claim 4, wherein the method of determining the problem solving ability of an individual by the system comprises the steps of:
generating a plurality of mathematical equations by the system, wherein each equator includes the use of each operator (+, −, x, /);
displaying the plurality of equations to the individual for a pre-determined period of time;
removing the plurality of equations by the system;
instructing the individual to provide an answer to each previously displayed equation; and
calculating a score for this task by the system by determining the correct amount of answers entered by the individual.

10. The method of claim 4, wherein the method of determining the problem solving ability of an individual by the system comprises the steps of:
generating a first image by the system;
providing a set of a least three images to the individual by the system;
instructing the individual by the system to select the image from the set of at least three images that is a rotated version of the first image;
entering the selected image into the system by the individual; and
determining by the system whether the selected image is correct.

11. The method of claim 4, wherein the method of determining the degradation of muscle control of an individual by the system comprises the steps of:
generating a shape by the system;
instructing the individual to trace within the lines of the shape;
determining by the number of times by the system when the individual falls outside of the lines of the shape;
calculating and storing by the system a score for this task.

12. The method of claim 4, wherein the method of determining the level of diplopia of an individual by the system comprises the steps of:
generating a grouping of lines by the system;
providing a scrollable menu by the system of possible counts to the individual;
selecting the amount of lines by the individual to enter into the system; and
determining by the system whether the input selected by the individual is correct.

13. The method of claim 4, wherein the method of determining the memory impairment of an individual by the system comprises the steps of:
generating at least one four-trial random dot reaction timer by the system;
displaying a circle by the system;
lighting up the circle at least four distinct times;
requiring the individual to contact the system following the lighting up of the circle; and
determining the amount of time by the system between the lighting up of the circle and the contact by the individual.
